(19) United States
(12) Patent Application Publication
(10) Pub. No.: US 2014/0319440 A1
(43) Pub. Date: Oct. 30, 2014

(54) ELECTRIC HOIST

(71) Applicant: Kouzo Kataoka, Osaka (JP)

(72) Inventor: Kouzo Kataoka, Osaka (JP)

(73) Assignee: HHH MANUFACTURING CO., Osaka (JP)

(21) Appl. No.: 14/356,950

(22) PCT Filed: Jul. 17, 2012
(86) PCT No.: PCT/JP2012/068062

§ 371 Date: May 8, 2014

(51) Int. Cl. B66D 3/20

(52) U.S. Cl. CPC B66D 3/20
USPC 254/334

(57) ABSTRACT

An electric hoist with a brake motor having an output shaft oriented in the horizontal direction; a shaft located immediately below the output shaft of the brake motor and pivoting parallel to the output shaft; a chain sprocket affixed on the shaft and having a load chain wound thereon; gears provided on the output shaft side of the brake motor, the gears meshing with each other between the output shaft and one end of the shaft and transmitting the output of the brake motor to the shaft; and an upper hook provided above the brake motor and horizontally suspending the shaft with no load suspended, the shaft connected to the brake motor through the gears. The chain sprocket is provided on the shaft such that the portion of the chain sprocket on which the load chain is wound is located on the vertical line which passes through the upper hook.

### TECHNICAL FIELD

The present invention relates to electric hoists usable in a state suspended at one point by a hook, and in particular relates to a new electric hoist having an improved structure including a motor and a wire drum so that the hoist continuously remains to be horizontally balanced regardless of whether a load is suspended from the hoist or not.

### BACKGROUND ART

An electric hoist lifts up or lifts down a load by causing a motor to rotate a wire drum or a chain sprocket in a normal direction or a reverse direction. When the load is lifted to a desired height, the motor is stopped and a braking function to keep the load at this height is thus provided. For this reason, it is rational that the electric hoist provides a brake motor. The brake motor includes on the side opposite the output shaft thereof an internal structure in which a rotor is slidably arranged between a brake lining and a fixed coil. In a switch-off mode, appropriate urging means, such as a spring, presses the rotor against the brake lining for braking In this way, the load is kept standstill at the desired height. In a switch-on mode, the fixed coil is excited, moving the rotor towards the fixed coil with the magnetic attractive force. The rotor is spaced from the brake lining, thereby allowing rotation driving. In this way, the load is lifted up or lifted down. The brake motor is thus provided with the function required of the electric hoist. The brake motor is not only simple in structure but also low-cost.

The brake motor thus constructed is known, and is referred to as an axial gap brake motor or an air gap brake motor, and is also referred to AG motor in short. In view of the braking operation, the above-described brake motor may also be referred to as a spring-driven brake motor.

Another type of brake motor known includes a speed reducer integrally disposed with the output shaft thereof. The brake motor with speed reducer is also referred to as a geared motor with brake. The brake motor with speed reducer increases torque thereof because of a speed reduction effect. The electric hoist including the brake motor with speed reducer advantageously handles an increased hoist load.

The easiest method to construct an electric hoist using such a brake motor is to directly connect a wire drum or a chain sprocket to the output shaft thereof. This direct connection structure causes the motor and the wire drum to be coaxially aligned. With no load suspended, the center of gravity shifts from the wire drum towards the motor that is heavier than the wire drum. If a hook is attached to the center of gravity point, the electric hoist with no load applied is suspended in a horizontal posture thereof. However, the weight of a load is typically heavier than the weight of the motor. During a loading and unloading operation, the center of gravity shifts towards the wire drum. As illustrated in FIG. 4, the whole electric hoist is greatly tilted about a hook F as a fulcrum point with the wire drum D moving downward. The electric hoist is unable to hoist the load in the state of FIG. 4. The electric hoist having the direct connection structure is difficult to use in a state suspended from a hook at one point. More specifically, the electric hoist having the direct connection structure is not assumed to be used in the suspension state of FIG. 4. The electric hoist having the direct connection structure, when used, is typically secured to a bracket B or the like in a workplace as illustrated in FIG. 5. In such a mode of use, however, a strong bracket supporting the bracket B is required. An installation operation is more complex than with the suspension type electric hoist. This type of electric hoist is inconvenient because the electric hoist, once installed, is difficult to move the installation location thereof.

The inventor of this invention has developed an a suspension type electric hoist that still has the direct connection structure but is able to continuously maintain to be horizontally balanced (Prior Art 1). This electric hoist includes direction reversing rollers R1 and R2 as illustrated in FIG. 6. A wire rope WR paid out from a wire drum D via the rollers R1 and R2 is aligned with a vertical line that passes the center C of gravity of the whole hoist. More specifically, the first roller R1 bends the wire rope WR downward paid out from the wire drum D horizontally toward the center C of gravity, and the second roller R2 bends the wire rope WR horizontally running from the first roller R1 vertically downward. Therefore, the center C of gravity remains unchanged even if the electric hoist changes from the no-load state to the load-hosting operation, and the electric hoist continuously maintains to be horizontally balanced.

### CITATION LIST

### Prior Art

Prior Art 1: WO2004/056689

### SUMMARY OF INVENTION

### Technical Problem

The electric hoist disclosed in Prior Art 1 is a wire hoist. If a wire drum D is substituted for a chain sprocket, the wire hoist becomes a chain hoist in terms of appearance. However, it is difficult for the first and second rollers to bend a strong load chain for loading at a right angle. The electric hoist disclosed in Prior Art 1 may not be used as a chain hoist in practice.

The electric hoist disclosed in Prior Art 1 may be used as a wire hoist as is. In this usage, the first and second rollers R1 and R2 bend the wire rope WP at a horizontal direction against the load, and the wire rope WR is easy to be damaged.

Since the payout position of the wire rope WR from the wire drum D is permanently fixed by the first roller, the wire rope WR is always taken up at the same position on the wire drum D. As a result, the wire rope WR overlaps one winding after another in multilayers. The wire rope WR may be entangled, or multilayered winding of the wire rope WR may jolt out during the lift up and lift down operation of the load. Vibrations and sound may frequently occur as a result.

One object of the present invention is to provide a chain-type electric hoist (chain hoist) that continuously maintains horizontal balance.

Another object of the present invention is to provide a wire-type electric hoist that is excellent in horizontal balance without the need to force-reverse the direction of the wire rope.

### Solution to Problem

To achieve the above objects, the electric hoist includes a brake motor having an output shaft oriented in a horizontal direction, a shaft located immediately below the output shaft of the brake motor, and configured to rotate in parallel with the output shaft, a chain sprocket affixed to the shaft and having a load chain entrained thereon, a plurality of gears disposed on the output shaft side of the brake motor, geared with each other between the output shaft and one end of the shaft, connecting the brake motor to the shaft, and configured to transmit the output of the brake motor to the shaft, and an upper hook disposed above the brake motor and configured to suspend the shaft in a horizontally aligned position with no load applied, wherein the chain sprocket is provided on the shaft in such a manner that a portion of the chain sprocket on which the load chain is entrained is aligned with a vertical line which passes through the upper hook.

As described above, the chain hoist includes the chain sprocket. The upper hook arranged above the brake motor is a fixture with which the chain hoist is suspended from any location at a point. The mounting location of the upper hook is set so that the shaft stays horizontal with no load applied. As a result, the upper hook is positioned right above the center of gravity of the whole hoist completed with the components thereof. With reference to the center of gravity, the load chain wound portion of the chain sprocket is aligned with the vertical line passing through the upper hook serving as a reference point. With this arrangement, the center of gravity of the whole hoist is free from shifting to rightward or leftward regardless of the no-load state with the load chain simply wound around the chain sprocket or the load suspended state with the load chain suspending the load. The electric hoist of the present invention suspended at the upper hook continuously maintains the horizontal balance in the no-load state and the load-suspended state.

The chain hoist has been described. If a wire drum having a winding shaft to take up a wire rope is provided in place of the chain sprocket on the shaft, a wire hoist is constructed. If the wire drum is fixed in a manner such that the winding shaft thereof is aligned with the vertical line that passes through the upper hook, the horizontal balance is maintained in the same manner as in the chain hoist without the need to force-change the running direction of the wire rope using another member such as a roller.

To ensure the winding length of the wire rope, the wire drum has a winding shaft shaped in a cylinder having a length. The center of gravity slightly shifts depending on the position of the wire rope on the winding shaft. If the wire hoist employs a wire drum, the center point of the winding shaft is preferably aligned with the vertical line. With this arrangement, the whole hoist is reliably maintained to be horizontally balanced at least in the no-load state. During the load hoisting operation, the center of gravity slightly laterally shifts depending on the winding position of the wire rope as described above. In accordance with the present invention, however, the center of gravity of the whole hoist is lowered by arranging the wire drum immediately below the brake motor. The tilt angle of the whole hoist caused by a lateral shift in the center of gravity is controlled to within a range that does not affect the loading and unloading operation.

The brake motor known in the related art and described in the Background Art section is employed in the present invention from functionality and economical points of view. When an operation switch is set to be off, the motor stops. At the same time, the brake function keeps the load to a standstill at a desired position. The brake motor may be switched between a lift up operation and a lift down operation by the operation switch. The direction of rotation of the shaft connected to the brake motor via a plurality of gears is determined by the number of gears. More specifically, if the number of gears is an odd number above three, the shaft rotates in the same direction as the brake motor, and if the number of gears is an even number above two, the shaft rotates in the opposite direction to the rotation of the brake motor. In any case, the lift up operation or the lift down operation is selectable.

Generally, the output of a motor is speed-reduced, resulting torque increases accordingly. In the case of the electrical hoist, this means a heavier hoist load weight. In the brake motor of the present invention, preferably, the brake motor integrally includes a speed reduction mechanism on the output shaft side thereof.

The plurality of gears varies the output of the brake motor in speed and transmits the speed-varied output to the shaft. By varying the gear ratio, the output of the brake motor is reduced or increased to a desired speed and then transmitted to the shaft.

The electric hoist of the present invention may include in place of the plurality of gears, arranged between the output shaft of the brake motor and the one end of the shaft, one pulley on the output shaft, another pulley on the one end of shaft, and a belt drive arranged between the two pulleys, wherein the belt drive transmits the output of the brake motor to the shaft. In this case, a timing belt or a V belt, having a large frictional force, is preferably employed. A flat belt or another type of belt drive may be employed. By using the two pulleys different in diameter, the output of the brake motor may be varied in speed, and then transmitted to the shaft in the same manner as when the gear ratio is changed.

### Advantageous Effects of Invention

The present invention provides a suspension-type chain hoist that is horizontally balanced not only during the no-load condition but also during the loading and unloading operation. The present invention provides a suspension-type wire hoist that is excellent in horizontal balance and low-noise properties without the need to force-change the direction of the wire rope. Since the hoist is suspended with the upper hook in each case, the hoist features easy installation, and provides a wider option in the selection of workplace for loading and unloading operation.

Since the chain sprocket or the wire drum are mounted immediately below the brake motor, the whole hoist has the center of gravity lower in height than the related art hoist featuring the direct connection structure, and thus suffers from a smaller swing during loading and unloading operation. Also in comparison with the related art direct connection structure, the entire lateral length of the hoist is small, leading to a better horizontal balance.

### BRIEF DESCRIPTION OF DRAWINGS

FIG. 1 is a front view of a chain hoist according to a first embodiment of the present invention.

FIG. 2 is a front view of a wire hoist of a second embodiment of the present invention.

FIG. 3 is a side view of a modification of a belt drive as a transmission mechanism.

FIG. 4 illustrates a related art electrical hoist that is used in a suspended state.

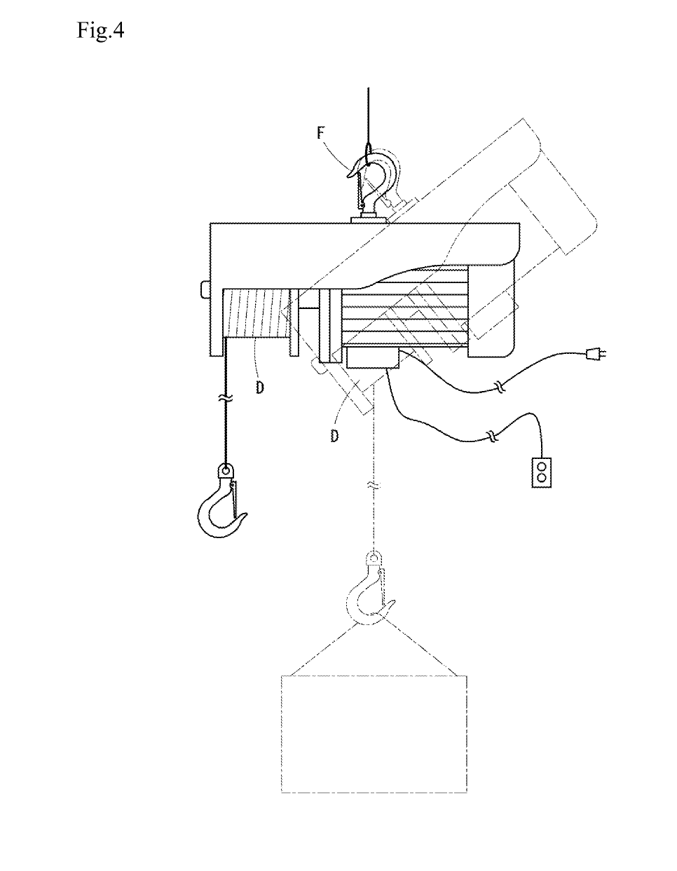

FIG. 5 illustrates the electric hoist of FIG. 4 in an appropriate mode of use.

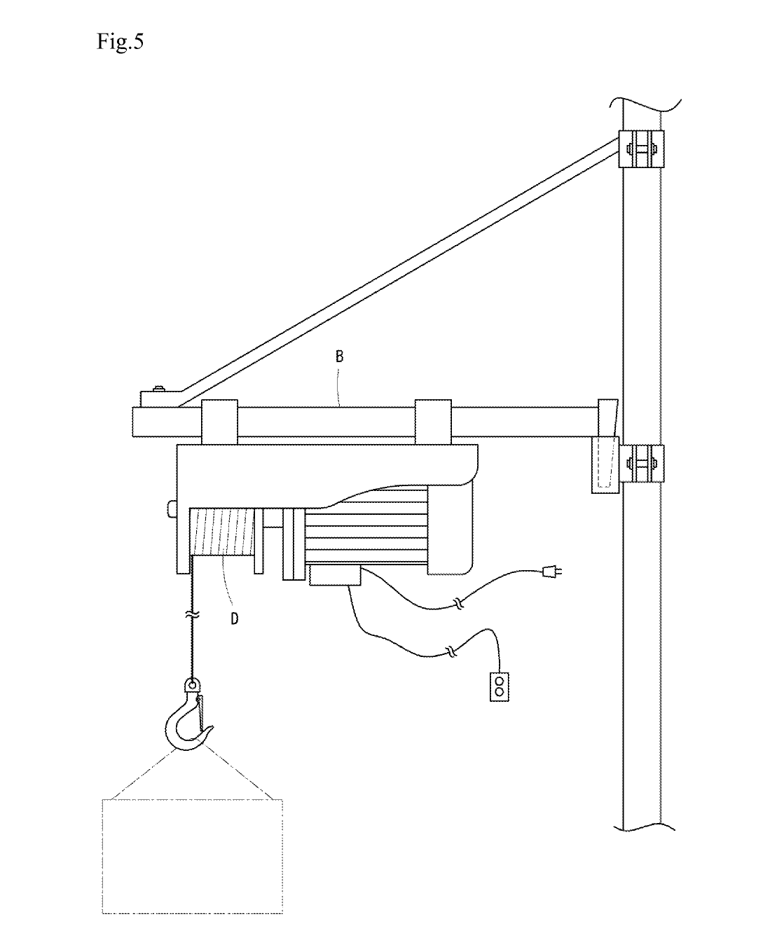

FIG. 6 illustrates an electric hoist disclosed in PTL 1.

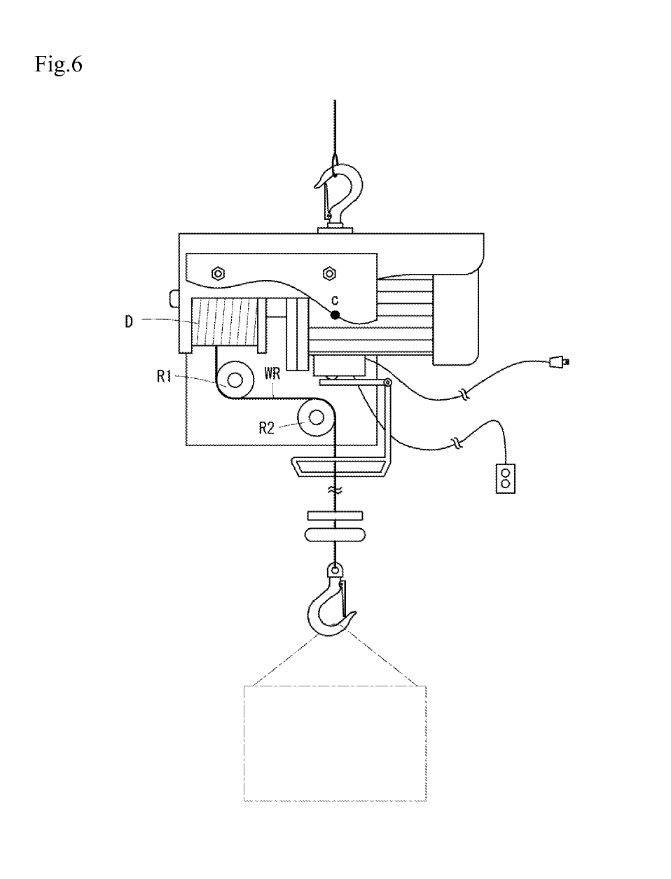

### DESCRIPTION OF EMBODIMENTS

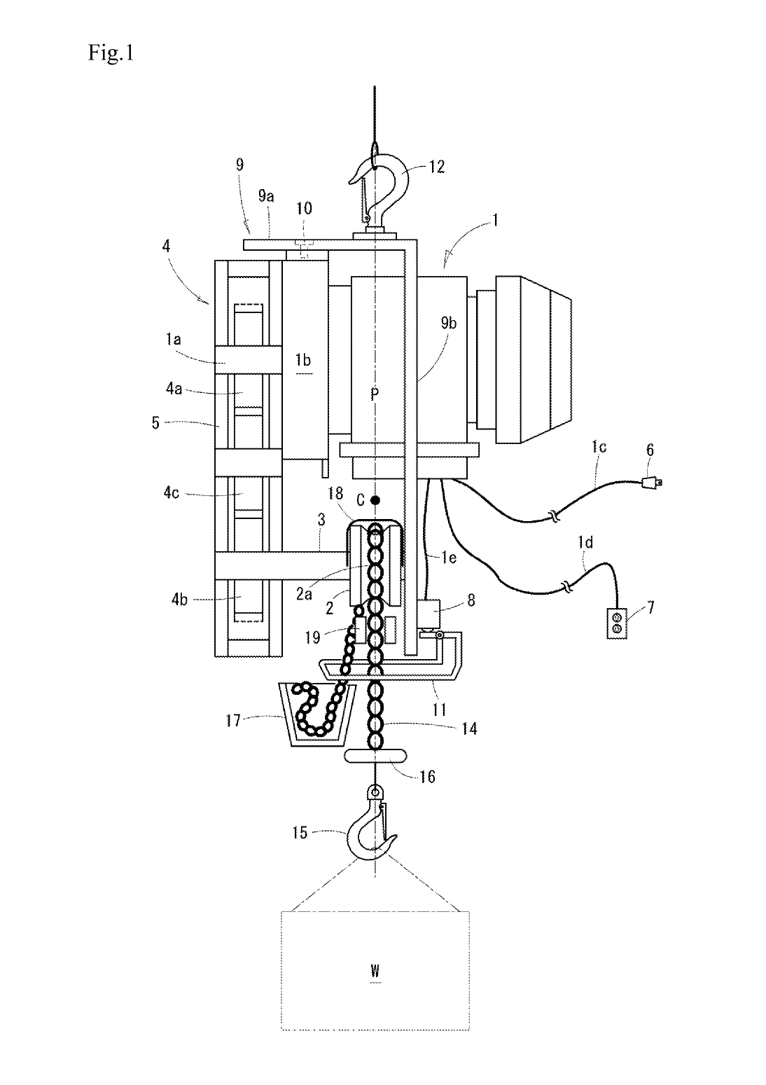

Embodiments of the present invention are described below with reference to the drawings. FIG. 1 is a front view of a chain hoist according to a first embodiment of the present invention. The chain hoist has a dual structure including a brake motor 1 as a driving source and a shaft 3 affixed immediately below the brake motor 1 and having a chain sprocket 2. The brake motor 1 and the shaft 3 are connected to each other via a transmission mechanism 4 arranged on an output shaft 1a of the brake motor 1. The transmission mechanism 4 includes a plurality of gears geared with each other. In the present embodiment, the transmission mechanism 4 includes upper, intermediate, lower gears 4a through 4c with gear ratios therebetween being 1:1:1. The upper gear 4a is affixed to the output shaft 1a of the brake motor 1. The lower gear 4b is affixed to one end of the shaft 3 immediately below the output shaft 1a. The intermediate gear 4c is arranged between the upper and lower gears 4a and 4b to connect the output shaft 1a to the shaft 3. The upper, intermediate, and lower gears 4a, 4c, and 4b are housed in a gear case 5 so that no foreign matter is caught therebetween.

The brake motor 1 is a related-art speed-reducer loaded brake motor 1 integrally including a speed reducer 1b on the output shaft 1a. The output shaft 1a protrudes horizontally from the side face of an internal unit of the speed reducer 1b. The gear case 5 is fixed to the side face of the speed reducer 1b. The brake motor 1 includes three electric cords 1c-1e. The electric cord 1c is used for power supply, and terminated with a plug 6. The electric cord 1d is used for switching, and is terminated with an operation switch 7 that selects between lift up operation and lift down operation to switch the rotation direction of the brake motor 1. The electric cord 1e is connected to a limit switch 8.

The present embodiment includes a frame 9. The brake motor 1 and the shaft 3 are supported by the frame 9. The frame 9 is open to the gear case 5 and is L-shaped in a front view with a top horizontal plate 9a and a side plate 9b extending downward from the top horizontal plate 9a. The speed reducer 1b is secured to the bottom surface (lower surface) of the horizontal plate 9a of the frame 9 with a screw 10. The brake motor 1 is thus supported by the frame 9. The end of the shaft 3 opposite the gear case 5 is rotatably supported on an inner lower portion of the side plate 9b. The limit switch 8 is mounted on the outer surface of the side plate 9b. A push rod 11 is mounted below the limit switch 8 to turn on the limit switch 8.

An upper hook 12 is secured on the top surface of the horizontal plate 9a of the frame 9 to suspend the whole hoist. The mounting position of the upper hook 12 is immediately above the center C of gravity of the whole chain hoist. More specifically, if the center C of gravity, with the brake motor 1 and the shaft 3 mounted on the frame 9, and then connected to each other via the transmission mechanism 4, comes to point C, the upper hook 12 is aligned with a vertical line P that passes through the point C. If the chain hoist is suspended at this phase, the shaft 3 becomes horizontal. The term horizontal is intended to mean a direction that is perpendicular to the vertical line P.

After the mounting position of the upper hook 12 is determined as described above, the chain sprocket 2 is fixed to the shaft 3. The mounting position of the chain sprocket 2 is also aligned with the vertical line P. More specifically, a winding portion 2a of the chain sprocket 2 around which a load chain 14 is entrained is also aligned with the vertical line P.

Even if the load chain 14 is wound around the chain sprocket 2 supported at the fixed position, the center C of gravity is free from any lateral swing. The whole hoist remains horizontally balanced. Both of the load chain 14 are open-ended, and a lower hook 15 is attached to one end. In the no-load condition with the lower hook 15 suspending no load W, the chain hoist maintains to be horizontally balanced.

The load chain 14 is lifted up or lifted down along the vertical line P. When the load W is suspended from the lower hook 15, the center C of gravity is free from lateral swing. During the loading and unloading operation, the chain hoist is not tilted from the horizontal line.

In a detailed structure, a disk flange 16 is attached to the connection point of the lower hook 15. When the load W is hoisted, the flange 16 may lift the push rod 11 arranged below the frame 9. The operation switch 7 is then triggered, causing automatically the brake motor 1 to stop. In this way, an excessive lift up operation is controlled.

A surplus portion of the load chain 14 opposite the lower hook 15 out of the chain sprocket 2 is retracted in a bucket 17 during the lift up operation of the load. In this way, the surplus portion is prevented from falling and interfering with the loading and unloading operation.

More preferably, a cover 18 is provided above the chain sprocket 2. In this way, the load chain 14 will not come off the chain sprocket 2 inadvertently during the loading and unloading operation. A pair of guide rollers 19 is arranged on the right and left side and below the chain sprocket 2 to guide the load chain 14 precisely within the chain sprocket 2. The guide rollers 19 also control the swinging of the load chain 14.

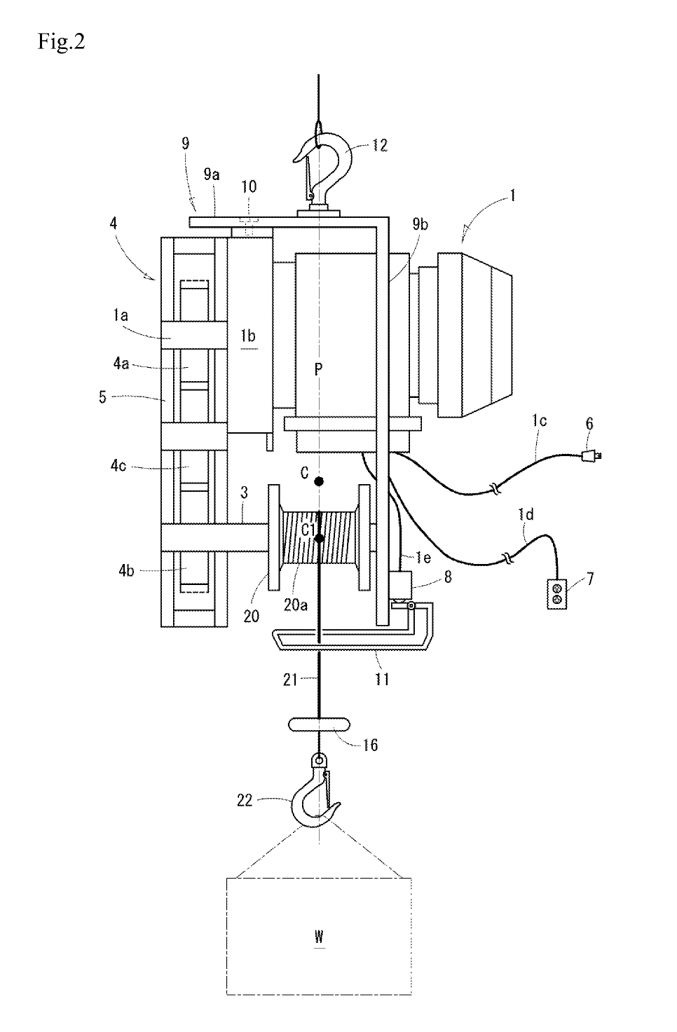

FIG. 2 is a front view of a wire hoist of a second embodiment of the present invention. A wire drum 20 in place of the chain sprocket 2 of the first embodiment is fixed to the shaft 3. One end of a wire rope 21 is fixed to the wire drum 20 and the wire rope 21 is taken up by a winding shaft 20a. A lower hook 22 is attached to the other end of the wire rope 21 to suspend the load W. The rest of the structure of the second embodiment remains unchanged from the first embodiment. Elements identical to those of the first embodiments are designated with the same reference numerals and the discussion thereof is omitted herein.

The winding shaft 20a of the wire drum 20 is aligned with the vertical line P. More preferably, the center point C1 of the winding shaft 20a is aligned with the vertical line P. The center point C1 is located at the same distance from both ends of the winding shaft 20a and as a result, is thus aligned with the center C of gravity of the wire drum 20.

With this arrangement, when the wire rope 21 is at the center point C of the wire drum 20, the wire rope 21 falls along the vertical line C. The wire hoist is free from tilting and maintains to be horizontally balanced regardless of whether no load is suspended or a load W is suspended.

When the load W is hoisted with the brake motor 1 operating, the wire rope 21 is wound around regularly on the winding shaft 20a while laterally moving. This arrangement prevents the wire rope 21 from being wound at the same location in a multi-layer fashion on the winding shaft 20a.

If the wire rope 21 laterally shifts during the loading and unloading operation, the center C of gravity also slightly moves. When the wire rope 21 is at each of the ends of the winding shaft 20a, the offset of the center of gravity becomes largest. However, since the wire drum 20 is located immediately below the brake motor 1, the center C of gravity is lower in height. The shaft length of the winding shaft 20a is shorter than the horizontal length of each of the brake motor 1 and the shaft 3. Even when the offset of the center C of gravity is maximized, the magnitude of tilt of the whole hoist is still small. The tilt angle is controlled to within a range that does not affect the loading and unloading operation.

The wire hoist of the second embodiment also provides excellent horizontal balancing property. The wire hoist of the second embodiment dispenses with the rollers guiding the wire rope 21 to the center of gravity, thereby keeping the wire rope 21 damage free. Since the wire rope 21 is not wound at a fixed position, but uniformly wound over the winding shaft 20a, an excellent low-noise property is provided.

Modifications that may be commonly incorporated in the two embodiments are described below. The brake motor 1 does not necessarily have to include the speed reducer 1b. Alternatively, if the gear ratio of the transmission mechanism 4 is set to be 1:1:2, the same speed reduction effect may be achieved. Conversely, if a gear ratio of 2:1:1 is used, a speed increasing effect may be achieved. Any gear ratio to achieve a desired speed change effect may be optionally set.

The number of gears is not limited to three including the upper, intermediate, and lower gears. A total of two gears, namely, the upper gear and the lower gear, may be used. A total of four gears, the upper gear, the lower gear, and two intermediate gears may be used. Note that if the number of gears is an odd number above three, the brake motor 1 and the shaft 3 rotate in the same direction, and that if the number of gears is an even number above two, the brake motor 1 and the shaft 3 rotates in the mutually opposite directions. In view of this, the lift up and lift down push button of the operation switch may be set up.

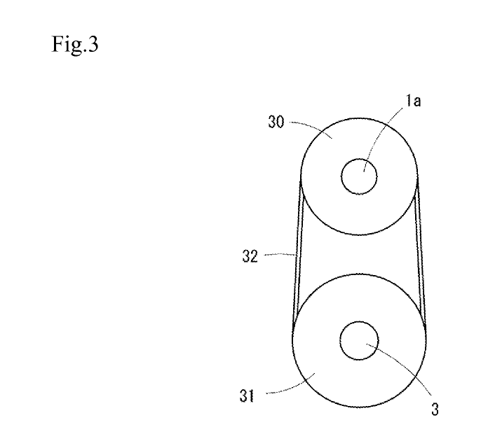

The transmission mechanism 4 may include a belt drive in place of the gear transmission. In such a case, as illustrated in FIG. 3, pulleys 30 and 31 are respectively attached to the output shaft 1a of the brake motor 1 and the one end of the shaft 3, and a timing belt drive 32 may be entrained about the pulleys 30 and 31. The pulleys 30 and 31 may or may not have the same diameter. If the pulleys 30 and 31 have the different diameters, a speed change effect may be achieved.

### REFERENCE SIGNS LIST

1 Brake motor
2 Chain sprocket
3 Shaft
4 Transmission mechanism (gears)
5 Gear case
9 Frame
12 Upper hook
14 Load chain
20 Wire drum
21 Wire rope

1. An electric hoist comprising:
a brake motor having an output shaft oriented in a horizontal direction;
a shaft located immediately below the output shaft of the brake motor, the shaft configured to rotate in parallel with the output shaft;
a chain sprocket affixed to the shaft and having a load chain entrained thereon;
a plurality of gears disposed on an output shaft side of the brake motor, the plurality of gears geared with each other between the output shaft and one end of the shaft, connecting the brake motor to the shaft, and configured to transmit an output of the brake motor to the shaft; and
an upper hook disposed above the brake motor and configured to suspend the shaft in a horizontally aligned position with no load applied;
wherein the chain sprocket is provided on the shaft in such a manner that a portion of the chain sprocket on which the load chain is entrained is aligned with a vertical line which passes through the upper hook.

2. (canceled)

3. The electric hoist according to claim 7, wherein a center of the winding shaft is aligned with the vertical line.

4. The electric hoist according to claim 1, wherein the brake motor integrally includes a speed reduction mechanism on the output shaft side thereof.

5. The electric hoist according to claim 1, wherein the plurality of gears varies the output of the brake motor in speed and transmits a speed-varied output to the shaft.

6. (canceled)

7. An electric hoist comprising:
a brake motor having an output shaft oriented in a horizontal direction;
a shaft located immediately below the output shaft of the brake motor, the shaft configured to rotate in parallel with the output shaft;
a wire drum affixed to the shaft, the wire drum having a winding shaft to take up a wire rope;
a plurality of gears disposed on an output shaft side of the brake motor, the plurality of gears geared with each other between the output shaft and one end of the shaft, connecting the brake motor to the shaft, and configured to transmit an output of the brake motor to the shaft; and
an upper hook disposed above the brake motor and configured to suspend the shaft in a horizontally aligned position with no load applied;
wherein the wire drum is provided on the shaft in such a manner that the winding shaft is aligned with a vertical line which passes through the upper hook.

8. An electric hoist comprising:
a brake motor having an output shaft oriented in a horizontal direction;
a shaft located immediately below the output shaft of the brake motor, the shaft configured to rotate in parallel with the output shaft;
a chain sprocket affixed to the shaft and having a load chain entrained thereon;
a first pulley, a second pulley, and a belt drive arranged therebetween, wherein the first pulley is on the output shaft, wherein the second pulley is on one end of the shaft, and wherein the belt drive transmits an output of the brake motor to the shaft; and
an upper hook disposed above the brake motor and configured to suspend the shaft in a horizontally aligned position with no load applied;
wherein the chain sprocket is provided on the shaft in such a manner that a portion of the chain sprocket on which the load chain is entrained is aligned with a vertical line which passes through the upper hook.
